(19) United States
(12) Patent Application Publication
(10) Pub. No.: US 2010/0299872 A1
(43) Pub. Date: Dec. 2, 2010

(54) HINGE FOR SPECTACLES

(75) Inventor: Ulrich Wannenmacher, Karlsdorf (DE)

Correspondence Address: HARNESS, DICKEY & PIERCE, P.L.C., P.O. BOX 828, BLOOMFIELD HILLS, MI, 48303, US

(73) Assignee: OBE OHNMACHT & BAUMGARTNER GmGH & CO. KG, Ispringen (DE)

(21) Appl. No.: 12/680,489

(22) PCT Filed: Sep. 25, 2008
(86) PCT No.: PCT/EP2008/008119

§ 371 Date: Mar. 26, 2010

(30) Foreign Application Priority Data
Sep. 27, 2007 (DE) 10 2007 048 011.5

(51) Int. Cl. G02C 5/22

(52) U.S. Cl. 16/228

(57) ABSTRACT

A hinge (1) for eyeglasses is provided, comprising
a central part and earpieces emerging therefrom,
a first hinge part (3) which is provided on the central part,
a second hinge part (5) which is provided on the earpiece, wherein
one of the hinge parts (3) has at least three tabs (13, 13a, 13b) situated at a distance from one another, and
one of the hinge parts (5) has at least two tabs (15, 15a) which are situated at a distance from one another in such a way that the tabs can be positioned in the gaps between the tabs of the other hinge part,
the tabs each have a through hole through which
a screw (11) provided with an external thread (47) and a head (43) extends in the assembled state of the hinge (1), and wherein
two adjacent tabs (13, 13a) are provided, of which only one has a through hole (33) having an internal thread (35), and the other tab is provided with a through hole (37), the inside diameter of which is selected in such a way that the through hole does not cooperate with the external thread (47) of the screw (11).

The hinge is characterized in that
the through holes (29, 31) of at least two of the three tabs (13b, 13a) of the one hinge part (3) are provided with internal threads (31, 35) which cooperate with the external thread (47) of the screw (11).

The invention relates to a hinge for eyeglasses according to the preamble of claim 1.

Hinges for eyeglasses are known, and are used for connecting the central part of an eyeglass to earpieces. In each case a first hinge part is provided on the central part of the eyeglass, and a second hinge part is provided on the earpiece. For example, one of the hinge parts has three tabs, i.e., projections, and the other hinge part has two tabs, which are situated at a distance from one another. Two interspaced tabs engage with the gaps between three tabs of the other hinge part. The two hinge parts are generally connected by a screw which extends into through holes in the tabs. The screw is used as a pivot axis for the two hinge parts, so that the earpieces are supported in a pivotably movable manner relative to the central part of the eyeglass. The connection between the earpieces and the central part is preferably established using snap spring hinges, for which a first hinge part is mounted on the central part of the eyeglass and the second hinge part is mounted on an earpiece. One of the hinge parts, generally the one on the earpiece, is specifically designed to be able to exert an elastic force on the earpiece. This elastic force is used to improve the wear comfort of the eyeglasses. The hinge parts are also designed in such a way that the earpieces preferably occupy predetermined positions relative to the central part of the eyeglass. Spring hinges of the type discussed here are known, and therefore require no further description. It has been found that hinges having hinge parts of the type discussed here are relatively stable due to the fact that the two tabs of the one hinge part are securely guided between the three tabs of the other hinge part. It is critical that a small amount of play is provided between the hinge parts. Minimal friction between the two hinge parts is particularly advantageous, especially when snap spring hinges are used. For assembly of the hinge, the screw is inserted into the through holes in the tabs of the hinge parts and tightened. An external thread of the screw cooperates with an internal thread on one of the tabs of the hinge parts, while the head of the screw on a side facing the hinge presses on one of the tabs of the hinge. When the screw is tightened, forces directed in the direction of the center axis of the screw act on the tabs of the hinge, thus pressing the tabs together. To prevent the screw from coming loose, in particular when the earpieces are repeatedly swiveled relative to the central part of the eyeglass, the screw must be tightened with a predetermined torque. As a rule, it is not simple to prevent the tabs of the hinge parts from pressing excessively against one another in order to limit the friction of the hinge parts to a desired minimum. However, if the screw is not tightened securely enough, it may fall out upon repeated use of the eyeglass, and the earpiece may come loose from the central part of the eyeglass. This may cause the earpiece to fall down, at the minimum causing damage thereto.

The object of the invention, therefore, is to provide a hinge for eyeglasses which on the one hand ensures minimal overall play, and on the other hand ensures very low friction between the hinge parts.

This object is achieved by providing a hinge of the aforementioned type which has the features of claim 1. The hinge has two hinge parts, of which a first hinge part is provided on the central part and a second hinge part is provided on the earpiece to ensure a pivotably movable connection between the earpiece and the central part. One of the hinge parts is provided with three tabs which are situated at a distance from one another. Two tabs of the other hinge part are situated in the gaps thus created. A screw which extends into through holes in the tabs connects the hinge parts in a pivotably movable manner. The screw is provided with an external thread and a head to ensure a secure connection of the hinge parts. In the assembled state of the hinge, two adjacent tabs are provided, of which only one has a through hole with an internal thread, whereas the other tab is provided with a through hole whose inner diameter is large enough that it does not cooperate with the external thread of the screw. However, it is provided that the inner face of the through hole preferably guides the screw. The hinge is characterized in that for the hinge part having three tabs, it is provided that at least two through holes are provided with an internal thread, which need not extend over the entire thickness of the respective tabs. The internal thread cooperates with the external thread of the screw. When the screw is inserted into the through holes and brought into engagement with the internal thread of the two tabs, it is ensured that, even when the screw is tightened, the distance between the two tabs having the internal thread remains unchanged. Thus, for a hinge part having three tabs, two adjacent tabs having an internal thread are provided, i.e., an outer tab and the inner tab. The tab whose through hole has no internal thread, and which therefore does not cooperate with the external thread of the screw, is provided on the other side of the inner tab. Thus, when the screw extends into the through holes of the tabs and is tightened, the tab which does not cooperate with the external thread of the screw is pulled against the inner tab. The distance between the inner tab and this outer tab is thus reduced, so that at this location the tab of the other hinge part is acted on by defined frictional forces. The deformation of the tab causes restoring forces to develop which generate frictional forces between the tab and the screw head and prevent inadvertent loosening. The pressing of the outer tab of one hinge part against the tab of the other hinge part on the one hand results in increased stability. On the other hand, a defined frictional force is developed. As the result of the distance between the two tabs provided with an internal thread remaining constant, even when the screw is tightened, no additional frictional forces are generated at this location. The play between the two tabs provided with an internal thread is set in such a way that minimal overall play of the hinge results at this location.

One preferred exemplary embodiment of the hinge is characterized in that the distance between the two tabs of the one hinge part, of which only one has an internal thread, is greater than the thickness of the tab of the other hinge part which may be situated between the two tabs. Thus, there are no joint problems when the hinge parts are brought together. Tightening the screws decreases the distance, so that, as described above, deformation of a tab is achieved.

One particularly preferred exemplary embodiment of the hinge is characterized in that the through hole in the tab without an internal thread for the hinge part having at least three tabs has a conical design, at least in places, at least one region of the head of the screw likewise being conical. The cone angles are matched to one another so that the outer cone of the screw head engages in the inner cone on the through hole, and frictional forces may be developed which reliably prevent loosening of the screw even when the earpieces are swiveled with respect to the central part of the eyeglass.

A further particularly preferred exemplary embodiment of the hinge is characterized in that the screw is provided with a plastic element which cooperates with the conical through hole. The frictional forces used to secure the screw may be set in a wide range by the selection of the plastic.

Further embodiments result from the subclaims.

The invention is explained in greater detail below with reference to the figures, which show the following:

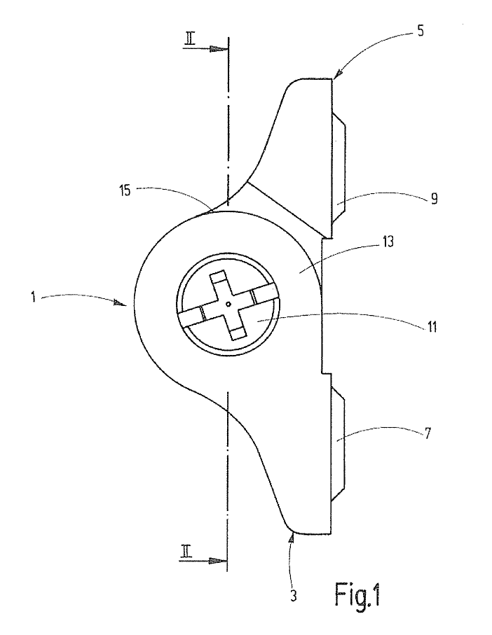

FIG. 1 shows a first exemplary embodiment of a hinge in a side view;

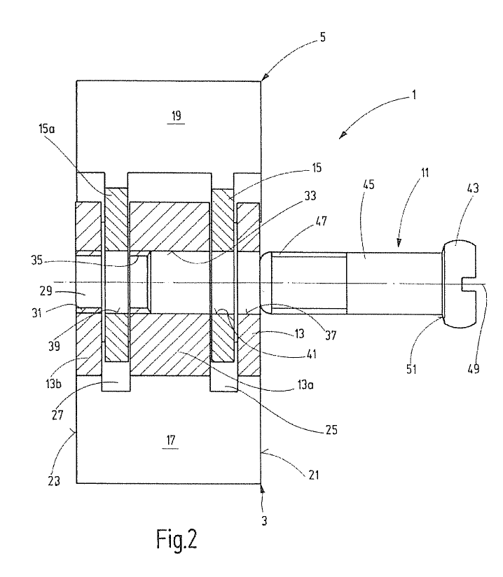

FIG. 2 shows a section along line II-II illustrated in FIG. 1, through the hinge illustrated according to FIG. 1 together with a screw, in an exploded illustration;

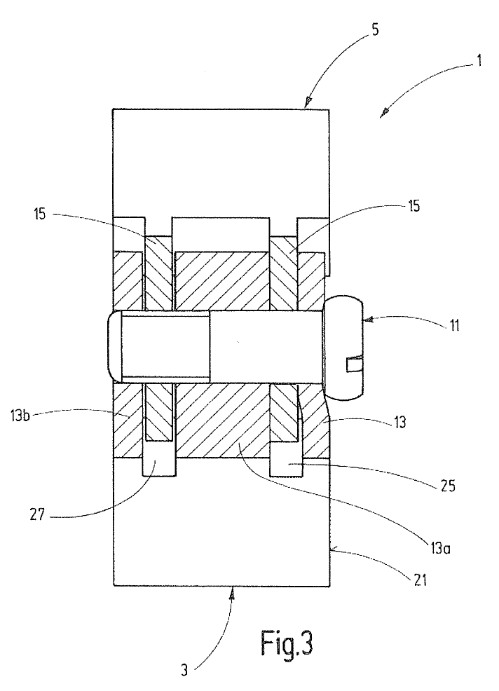

FIG. 3 shows the hinge according to FIG. 2 with the screw tightened;

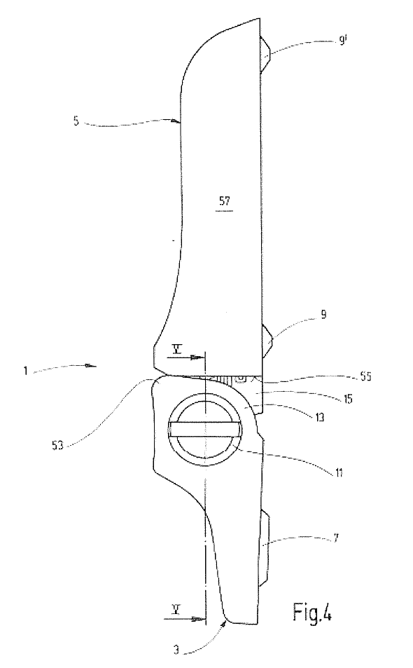

FIG. 4 shows a second exemplary embodiment of a hinge in a side view;

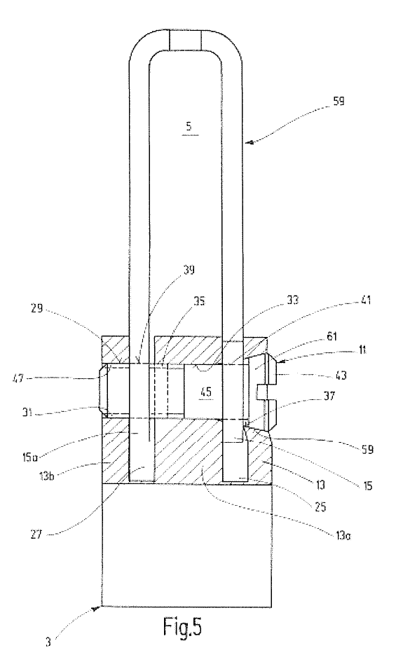

FIG. 5 shows a section along line V-V illustrated in FIG. 4; and

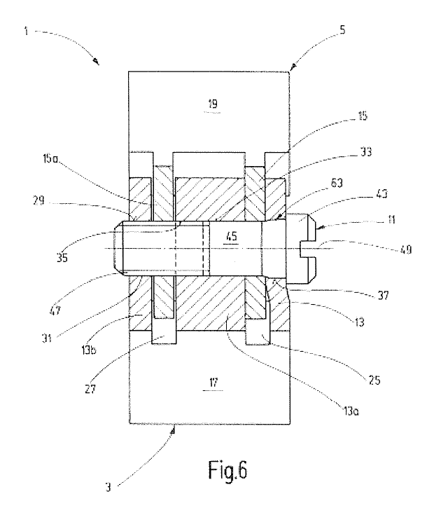

FIG. 6 shows a third exemplary embodiment of a hinge, with the screw tightened.

The hinge 1 illustrated in a side view in FIG. 1 is used to connect a central part of an eyeglass (not illustrated) to an earpiece in such a way that the earpiece is held in a pivotably movable manner relative to the central part. The hinge 1 has a first hinge part 3 and a second hinge part 5, whereby the first hinge part 3 may be associated with an earpiece and the second hinge part 5 may be associated with the central part of the eyeglass. Both hinge parts 3 and 5 are provided here by way of example with welding studs 7, 9, which are used in particular to connect the hinge parts 3, 5 to the central part or to the earpiece of an eyeglass by means of electric welding. However, the hinge parts 3, 5 may be connected to the central parts or earpieces in some other way, and welding studs may be dispensed with.

The hinge parts 3 and 5 are provided with projections, referred to as tabs, which are joined together in a pivotably movable manner by a connecting element, for example a screw 11, which extends through a perpendicular to the image plane of FIG. 1. For example, the first hinge part 3 is provided with three tabs situated in parallel at a distance from one another, of which a first tab 13 is visible here. Tabs of the second hinge part are situated in the interspaces between the tabs of the first hinge part, so that the tabs of the two hinge parts engage with one another. In the present case a first tab 15 of the second hinge part 5 can be seen. The first hinge part generally has n tabs, whereas the second hinge part has n−1 tabs which are situated in the interspaces between the tabs of the first hinge part. In the following discussion it is assumed that the hinge 1 comprises a first hinge part 3 having three tabs and a second hinge part 5 having two tabs.

FIG. 2 shows a section through the hinge 1 along line II-II illustrated in FIG. 1 with the screw 11, in an exploded illustration; i.e., the screw 11 is not screwed into the hinge 1. The regions of the hinge 1 not shown in cross section are the welding studs 7 and 9, visible in FIG. 1, and oppositely facing top sides 17 and 19 of the hinge parts 3 and 5, respectively.

The illustration according to FIG. 2 shows that the first hinge part 3 has three tabs, the first tab 13 being in flush alignment with the right side face 21 of the first hinge part 3. A central tab 13a is situated at a distance therefrom. Also provided at a distance is a tab 13b which is in flush alignment with the left side face 23. This flush design allows the narrowest possible hinge 1 to be realized. This type of configuration is not absolutely necessary. It is important for the first hinge part 3 to have three tabs 13, 13a, 13b situated at a distance from one another, between which interspaces 25 and 27 are present due to the spacing between the tabs. Two tabs 15 and 15a of the second hinge part 5 are situated in the interspaces 25 and 27 of the three tabs of the first hinge part 3.

All of the tabs have through openings which are situated so that in the assembled state of the hinge 1 the through openings are flush with one another and are penetrated by the screw 11.

As shown in FIG. 2, an internal thread 31 is provided in tab 13b of the first hinge part 3 in the region of the through hole 29. In the exemplary embodiment illustrated here, this internal thread extends over the entire thickness of tab 13b. This is particularly meaningful when tab 13b is very thin.

The through hole 33 in central tab 13a of the first hinge part is also provided with an internal thread 35. In this case, however, this internal thread extends over only a portion of the thickness of central tab 13, and is situated in a region adjoining the interspace 27.

It is shown that the extension of the internal thread in the direction of the center axis of the through holes is variable. In particular in the region of tab 13a, which is generally thicker, a longer internal thread 31 may be provided which is able to absorb greater forces.

The first tab 13 of the first hinge part 1 is also provided with a through hole 37. However, the inner diameter thereof is selected such that said diameter is greater than the diameter in the region of the internal thread 35 or 31.

The through hole 39 in tab 15a and the through hole 41 in tab 15 of the second hinge part 5 are larger than the through hole in the region of the internal threads 31 and 35.

FIG. 2 shows the screw 11 in a side view. The screw comprises a head 43 and a shank 45, which is provided with an external thread 47 at least in the region facing away from the head 43. The external thread is matched to the internal threads 31 and 35 in such a way that the external thread meshes with the internal threads 31 and 35 but does not cooperate with the through holes 39 and 41 in tabs 15a and 15 of the second hinge part. The external thread 47 may lie against the inner face of these through holes 39, 41, thus providing a support or guide. However, there is no application of force at this location which develops appreciable forces which could displace the associated tabs in the direction of the longitudinal axis 49 of the screw 11. In addition, in this case it is ensured that the inner face of the through hole 37 in tab 13 also does not cooperate with the external thread 47, and at best acts as a guide for the screw 11.

The first hinge part 3 thus has two adjacent tabs 13 and 13a, of which only one, namely, central tab 13a, is provided with an internal thread. The first hinge part also has two adjacent tabs 13a and 13b, which are provided with an internal thread 35 and 31, respectively.

When the screw 11 is inserted into the hinge 1, the screw extends into through hole 37 in tab 13 and into through hole 41 in tab 15 without the external thread 47 of the screw engaging at this location. When the screw 11 is inserted further into the hinge 1, it engages in the internal thread 35 in through hole 33 of central tab 13a of the first hinge part 3. In order to insert the screw further into the hinge 1 in the direction of the longitudinal axis of the screw, the screw must be turned, its external thread 47 cooperating with internal thread 35 first. When the screw 11 exits internal thread 35 (to the left in FIG. 2), it passes into the region of through hole 39 in tab 15a of the second hinge part 5 without resulting in an interaction, typical for a thread, of the external thread 47 with tab 15a. Thus, tab 15a is not impinged by forces acting in the direction of the longitudinal axis 49 when the screw 11 is turned. When the screw 11 is turned further, its external thread ultimately reaches the internal thread 31 in tab 13b of the first hinge part 3. Upon further screwing of the screw 11 into the hinge 1, the underside 51 of the head 43 facing the shank 45 ultimately contacts the right side face 21 of tab 13. Further turning of the screw 11 causes it to be tightened, and the head 43 exerts a force on tab 13. This results in frictional forces between the underside 51 of the screw 43 and the right side face 21 of tab 13. This tab is deflected or bent to the left in FIG. 2, i.e., in the direction of central tab 13a of the first hinge part, causing it to be pressed against tab 15 of the second hinge part 5.

Since the external thread 47 of the screw 11 cooperates with the internal thread 35 in central tab 13a and also with the internal thread 31 of tab 13b, the distance between these two tabs 13a and 13b remains constant, even when the screw 11 is tightened. Thus, it is critical that an internal thread 35 or 31 is provided in the two adjacent tabs 13a and 13b, respectively, which cooperates with the external thread 47 of the screw 11. Thus, relative motion of the two tabs 13a and 13b in the direction of the longitudinal axis 49 of the screw 11 does not occur when the screw is tightened.

The frictional forces between tab 15a of the second hinge part 5 and adjacent tabs 13a and 13b of the first hinge part 3 may be adjusted by virtue of the width of the interspace 27, measured in the direction of the longitudinal axis 49. The distance between tabs 13a and 13b is preferably selected in such a way that a clearance fit with the interposed tab 15a results. This clearance fit is maintained even after the screw 11 is installed.

Thus, when the screw 11 is tightened, only tab 13 of the first hinge part 1 is pivoted or bent with respect to central tab 13a, so that the width of the interspace 25 is reduced and the interposed tab 15 of the second hinge part 5 is acted on by frictional forces.

FIG. 3 illustrates the hinge 1 with the screw 11 tightened. Identical parts are provided with the same reference numerals, so that reference is made to the description for the preceding figures to avoid repetition.

A comparison of FIGS. 2 and 3 shows that when the screw 11 is tightened, tab 13 of the first hinge part 3 has been deflected to the left from its initial position illustrated in FIG. 2, so that it is no longer flush over its entire length with the right side face 21 of the first hinge part 3, and is pressed against tab 15 of the second hinge part 5. The deflection of tab 13 of the first hinge part 1 to the left in the direction of central tab 13a reduces the width of the interspace 25, causing tab 15 of the second hinge part 5 to be wedged between tabs 13 and 13a of the first hinge part. The resulting frictional forces may be adjusted, depending on how securely the screw 11 is tightened, so that minimal friction may be achieved between the two hinge parts 3 and 5.

When the eyeglasses are used, i.e., when the hinge parts 3 and 5 are swiveled relative to one another, inadvertent loosening of the screw 11 is prevented by the fact that restoring forces are generated by the elastic deformation of tab 13, causing frictional forces to develop between tab 13 and the underside 51 of the head 43 of the screw 11.

A comparison of FIGS. 2 and 3 also shows that the distance between tabs 13a and 13b, and thus the width of the interspace 27, has not changed as the result of tightening the screw. As shown in FIG. 3, a displacement of the second hinge part 5 to the left relative to the third hinge parts 3 may result, causing tab 15a, which is freely movable in the interspace 27 relative to the external thread 47 of the screw 11, in FIG. 3 is displaced slightly farther to the left than in FIG. 2.

It is only critical that once the play between tabs 13a and 13b has been set by tightening the screw 11, the play is not changed. Anti-twist protection of the screw 11 is achieved due to the restoring forces of tab 13, and the contact pressure of the underside 51 on this tab upon tightening.

FIG. 4 shows a second exemplary embodiment of a hinge in a side view. Identical and functionally equivalent parts are provided with the same reference numerals, so that reference is made to the description for the preceding figures.

The hinge illustrated here also has two hinge parts 3 and 5 which are provided with tabs. As an example, in this case the first hinge part 3 is provided with three tabs and the second hinge part 5 is provided with two tabs which, the same as in the exemplary embodiment according to the preceding figures, engage with one another and are joined together by a screw 11.

In the present case the second hinge part 5 is larger because it is designed as a spring hinge and has a recess which contains a hinge element and a spring, so that tensile forces are exerted on the tabs of the second hinge part 5. The design and principle of operation of such a spring hinge are known, and therefore require no further description here.

The two hinge parts 3 and 5 of the hinge 1 are fastened to the central part and to an earpiece of an eyeglass, respectively. In this case, by way of example a welding stud 7 is provided on the first hinge part 3 and welding studs 9 and 9′ are provided on the second hinge part 5, by means of which the hinge 1 may be fastened to an eyeglass. The manner in which the hinge 1 is fastened to an eyeglass is not important for the principle of operation of the hinge.

The hinge 1 illustrated in FIG. 4 is implemented as a snap spring hinge. Both hinge parts 3 and 5 occupy preferred positions with respect to one another: The position of hinge parts 3 and 5 illustrated in FIG. 4 corresponds to the open position of an eyeglass earpiece relative to a central part of an eyeglass. When the second hinge part 5 is rotated counterclockwise relative to the first hinge part 3 by approximately 90°, a lobe 53 on tab 13 of the first hinge part slides, causing tabs 15 and 15′ of the second hinge part 5 to be pulled from a housing 57 against the force of a spring in the second hinge part 5.

The lobe 53 ensures that two preferred relative positions result between hinge parts 3 and 5. The first position is illustrated in FIG. 4. The other is the position in which the second hinge part 5 is swiveled counterclockwise relative to the first hinge part 3 by 90°. Snap spring hinges of the type discussed here are known, and their principle of operation therefore requires no further description here.

FIG. 5 shows a section along line V-V illustrated in FIG. 4. Identical and functionally equivalent parts are provided with the same reference numerals, so that reference is made to the description for the preceding figures.

In FIG. 5 portions of the second hinge part 5 have been omitted, in particular the housing 57 and the spring which is customary for a spring hinge. Shown here is a hinge element 59 having two tabs 15 and 15a which are situated between the three tabs 13, 13a, and 13b of the first hinge part 3, namely, in interspaces 25 and 27, as previously described with reference to FIGS. 2 and 3.

In the illustration according to FIG. 5 the screw 11 is tightened, causing tab 13 to be displaced to the left in FIG. 5 in the direction of tab 13a, so that the width of the interspace 25 is reduced in such a way that tab 15 is clamped at this location with a specified minimal frictional force.

Tab 15a is not wedged in the interspace 27 because an internal thread 31 and 35 is provided in respective through holes 29 and 33 in tabs 13b and 13a, as previously described with reference to FIGS. 2 and 3. The internal thread 35 of tab 13a is shown in dashed lines. This internal thread extends by way of example only over a relatively small portion of the thickness of tab 13a, which, here as well, is preferably thicker than the other tabs 13, 13b of the first hinge part 3. Once set, a lateral distance between tabs 13a and 13b is maintained even when the screw 11 is tightened. This function is independent of the particular region of the thickness of tabs 13a and 13b through which the internal thread extends. The external thread 47 of the screw 11 does not cooperate with through holes 39 and 41 in tabs 15a and 15, respectively, nor does it cooperate with through hole 37 in tab 13.

To increase the frictional forces between the head 43 of the screw 11 and tab 13, through hole 37 of tab 13 has at least one conical region. In the present case the entire through hole 37 is designed as an inner cone 59. Correspondingly, at least one region of the head 43 of the screw 11 is designed as an outer cone 61 which cooperates with the inner cone 59.

Whereas for the exemplary embodiment according to FIGS. 1 through 3 only the underside 51 of the head 43 of the screw 11 developed frictional forces as anti-twist protection as the result of contact with tab 13, in the present case it is the inner cone 59 and the outer cone 61, which have a much larger surface area than the underside 51 in the other exemplary embodiment [, which develop frictional forces]. This results in higher frictional forces which prevent inadvertent loosening of the screw 11. In the other exemplary embodiment, such forces could be achieved only by a very high tightening torque which, however, would also greatly increase the frictional forces between the two hinge parts 3 and 5.

Lastly, FIG. 6 shows a third exemplary embodiment of the hinge 1 which has a similar design to the exemplary embodiment according to FIGS. 1 through 3. Identical and functionally equivalent parts are provided with the same reference numerals. The present case involves a hinge 1 with two hinge parts 3 and 5 having three or two interlocking tabs, respectively, which are joined together via a screw 11 in a pivotably movable manner. Internal threads in two of the three tabs of the first hinge part 3 cooperate with an external thread 47 of the screw 11, so that the distance between these tabs does not change even when the screw 11 is tightened. The length of the internal thread 35, indicated by dashed lines and measured in the direction of longitudinal axis 49 of the screw 11, is much greater in this case than for the internal thread provided in the [other] exemplary embodiment[s]. The screw may thus be adapted to various load situations, and to the materials selected for the first hinge part 3.

Here as well, tab 13 of the first hinge part 3 is displaced in the direction of tab 13a of the first hinge part when the screw 11 is tightened, thus reducing the width of the interspace 25 between these two tabs and developing a defined frictional force with tab 15 of the second hinge part 5. Anti-twist protection of the screw 11 is provided by a plastic element 63 situated on the shank 45 of the screw in the immediate proximity of the head 43. The outer diameter of the plastic element is selected in such a way that it cooperates with the inner face in the region of the through hole 37 in tab 13 and develops frictional forces.

The outer face of the plastic element 63 may have a conical design, the same as the outer cone 61 on the head 43 of the screw in the exemplary embodiment according to FIG. 5. Correspondingly, an inner cone may also be provided in the region of the through hole 47 in tab 13.

The properties of the plastic element 63 are selected in such a way that relatively high frictional forces result between tab 13 and the screw 11, thus achieving anti-twist protection.

Such anti-twist protection is basically known, and therefore requires no further description here.

It is noted that such a plastic element may also be provided for the exemplary embodiment of the hinge 1 illustrated in FIGS. 4 and 5 in order to achieve anti-twist protection of the screw 11 and to protect the screw from loosening, also during use of the hinge 1.

1-11. (canceled)

12. A hinge for eyeglasses, the hinge comprising:
a central part and earpieces emerging therefrom;
a first hinge part provided on the central part;
a second hinge part provided on the earpiece;
one of the hinge parts having at least three tabs situated at a distance from one another;
one of the hinge parts having at least two tabs which are situated at a distance from one another in such a way that the tabs can be positioned in the gaps between the tabs of the other hinge part; and
the tabs each have a through hole through which a screw provided with an external thread and a head extends in an assembled state of the hinge;
wherein two adjacent tabs are provided, of which only one has a through hole having an internal thread, and the other tab is provided with a through hole, the inside diameter of which is selected in such a way that the through hole does not cooperate with the external thread of the screw; and
wherein the through holes of at least two of the three tabs of the one hinge part are provided with internal threads which cooperate with the external thread of the screw.

13. The hinge according to claim 12, wherein the hinge is designed as a spring hinge for eyeglasses.

14. The hinge according to claim 13, wherein the hinge is designed as a snap spring hinge for eyeglasses.

15. The hinge according to claim 12, wherein the distance between the two tabs of the one hinge part provided with an internal thread is selected in such a way that this distance is greater than the thickness of a tab of the other hinge part which may be situated between the tabs of the hinge part.

16. The hinge according to claim 15, wherein the distance between the two tabs of the one hinge part, of which only one has an internal thread, is greater than the thickness of the tab of the other hinge part which may be situated between the two tabs.

17. The hinge part according to claim 12, wherein the tab, without an internal thread, of the one hinge part having at least three tabs is elastically deformed by the screw when the hinge is assembled.

18. The hinge part according to claim 12, wherein the distance of the tab, without an internal thread, of the hinge part having at least three tabs, from an adjacent tab may be changed by means of the screw which connects the hinge parts.

19. The hinge part according to claim 12, wherein the through hole in the tab, without an internal thread, of the hinge part having at least three tabs, has a conical design, at least in places.

20. The hinge part according to claim 12, wherein the head of the screw has a conical design, at least in places.

21. The hinge part according to claim 12, wherein the screw has a plastic element adjacent to the head of the screw which cooperates with the through hole.

22. The hinge according to claim 21, wherein the plastic element has a conical design, at least in places.
